(19) United States
(12) Patent Application Publication
(10) Pub. No.: US 2003/0102950 A1
(43) Pub. Date: Jun. 5, 2003

(54) Electromagnet assembly for electromagnetic apparatus

(76) Inventor: Yoshiyuki Suda, Isesaki-shi (JP)

Correspondence Address: BAKER BOTTS LLP, C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 10/331,347

(22) Filed: Dec. 31, 2002

Related U.S. Application Data
(62) Division of application No. 09/788,442, filed on Feb. 21, 2001, now Pat. No. 6,512,440.

(30) Foreign Application Priority Data
Feb. 29, 2000 (JP) P2000-057932

(51) Int. Cl. H01F 27/30

(52) U.S. Cl. 336/198

(57) ABSTRACT

An electromagnet assembly for an electromagnetic apparatus has a ring member, a coil bobbin having an electrical wire wound a spool of the ring member, and a ring case. The ring member is disposed in an annular groove of the ring case. An opening is formed through the ring case adjacent to its closed end surface. A connector, which is disposed on the ring case and covers the opening, includes a case having a closed shape and a bottom, and a cap closing an open end of the case. Ends of the electrical wire and ends of a lead wire are joined in the connector. A projection portion is formed around a fringe portion of a first end surface of the cap and abuts an open end surface of the case. The cap is secured fixedly to the case after the projection portion is melted.

### BACKGROUND OF THE INVENTION

1. Field of the Invention

The present invention relates to an electromagnet assembly for use in an electromagnetic apparatus, such as an electromagnetic clutch for use in controlling the transmission of power from an automobile engine to a refrigerant compressor in an automobile air conditioning system. More particularly, it relates to a connector in the electromagnet assembly.

2. Description of Related Art

Referring to FIG. 1, an electromagnet assembly 7, which comprises a ring member 1, a coil bobbin 3, and a ring case 4, is known in the art. Ring member 1 has a toroidal shape having a spool portion, which has an exterior open edge formed by two annular flanges on the spool portion. Coil bobbin 3 has ring member 1 and an electrical wire 2, which is wound around the spool portion of ring member 1. Ring case 4 has an annular groove, an open edge of which is in a direction parallel to its axis. Coil bobbin 3 is inserted into the annular groove of ring case 4. An opening 4a is formed through ring case 4 adjacent to its closed end surface. A connector 5 is disposed on ring case 4 adjacent to its closed end surface and covers opening 4a. A first end 2a and a second end 2b of electrical wire 2 and a first lead 6a and a second lead 6b are joined, respectively in connector 5. Electromagnet assembly 7, for example, is used in an electromagnetic clutch 9 of a compressor 8 in an automobile air conditioning system, as shown in FIG. 2. Electromagnet assembly 7 engages compressor 8 through a ring-shaped plate 10, which is affixed to the closed end surface of ring case 4.

Referring to FIGS. 3-6, the connecting structure between connector 5 and ring case 4 and the wiring connecting structure in connector 5 is shown. As shown in FIGS. 3 and 4, connector 5 has a case 5a having a box shape including a bottom and a cap 5b, which closes an open end of case 5a. Case 5a is fixed to ring case 4 by a pair of first hooks 10a formed on ring-shaped plate 10 which engage a pair of first receiving portions 5a₁ formed on case 5a. Cap 5b is fixed to case 5a by engaging a plurality of second receiving portions 5a₂ formed at case 5a with a plurality of hooks 5b₁ formed at cap 5b. A projection portion 5a₃, which is formed on case 5a, is inserted into an opening 4a. An O-ring 11, which is disposed in an annular groove formed on case 5a, surrounds opening 4a and abuts the closed end surface of ring case 4.

As shown in FIGS. 4-6, first end 2a and second end 2b of electrical wire 2 are introduced into opening 4a through a notched portion 1a formed on a first end surface of ring member 1 and are extended into connector 5 through a pair of penetrating holes 5a₄, which are formed through projection portion 5a₃. A contact 12 having a first electric connection is connected to an end of second lead 6b, which is inserted into connector 5. In addition, contact 12 having a second electric connection is connected to an end of first lead 6a, which is inserted into connector 5. First end 2aof electrical wire 2 is supported between a first receiving portion formed at case 5aof connector 5 and a second receiving portion formed at contact 12, which is connected to first lead 6a. Second end 2b of electrical wire 2 is supported between a third receiving portion formed at case 5a of connector 5 and a fourth receiving portion formed at contact 12, which is connected to lead 6b. Thus, first end 2a and second end 2b of electrical wire 2 are connected to first lead 6a and second lead 6b, respectively.

Coil bobbin 3 is fixed to ring case 4 by a resin 13 (e.g., an epoxy resin), which is poured into an open end of the annular groove of ring case 4. O-ring 11, which is disposed between case 5a and the closed end surface of ring case 4, prevents resin 13 from leaking to the outside of the closed end surface of ring case 4 through the gap between projection portion 5a₃ of case 5a and a surrounding wall of opening 4a, when resin 13 is poured into ring case 4.

In a known electromagnet assembly for use in an electromagnetic apparatus, it is necessary to engage the plurality of hooks 5b₁ to the plurality of second receiving portions 5a₂ when cap 5b of connector 5 is fixed to case 5a. Therefore, the manufacturing efficiency of fixing cap 5b to case 5a is low because this process is done by hand. Further, if the interior of case 5a does not fill with resin, water may enter into the interior of case 5a through the gap between cap 5b and case 5a, which is adjacent to an engagement portion of hook 5bₗ and second receiving portion 5a₂ , and the insulation capabilities of connecting portions of first end 2a and second end 2b of electrical wire 2 and contact 12 may be reduced. Therefore, it may be necessary to refill the interior of case 5a with resin 13, and the manufacturing efficiency of fixing cap 5b to case 5a may be reduced.

### SUMMARY OF THE INVENTION

An object of the present invention is to provide an electromagnet assembly for use in an electromagnetic apparatus which has a greater manufacturing efficiency in fixing a cap to a case of a connector, when compared with a known electromagnet assembly.

In an embodiment of the present invention, an electromagnet assembly for an electromagnetic apparatus comprises a ring member, a coil bobbin, a ring case, and a connector. The ring member comprises a tubular spool, e.g., cylindrical spool, with a pair of annular flanges projecting radially from the spool. The coil bobbin comprises an electrical wire. The electrical wire is wound around the spool between the flanges. The ring case comprises an annular groove, which has an open edge. The coil bobbin is disposed in the ring case's annular groove. An opening is formed through the ring case adjacent to its closed end surface. The connector comprises a case and a cap. The case forms an enclosure, such as a cylinder or a box, having an open end and a bottom. The cap closes the open end of the case. The connector is disposed on the ring case adjacent to its closed end surface and covers the opening. A first end and a second end of the electrical wire, and a first lead wire and a second lead wire from an external electric circuit are connected to the first and the second ends, respectively in the connector. A projection portion is formed around a fringe portion of a first end surface of the cap and abuts an open end surface of the case. The cap is secured fixedly to the case after the projection portion is melted.

Other objects, features, and advantages will be apparent to persons of ordinary skill in the art from the following description of the invention with reference to the accompanying drawings.

### BRIEF DESCRIPTION OF THE DRAWINGS

The present invention may be more readily understood with reference to the following drawings.

FIG. 1 is a perspective and exploded view of a known electromagnet assembly for use in an electromagnetic apparatus.

FIG. 2 is a longitudinal, cross-sectional view of a known compressor for use in an automotive air-conditioning system, which includes an electromagnetic clutch having the known electromagnet assembly.

FIG. 3 is a plan view of a closed end surface side of a ring case of the known electromagnet assembly.

FIG. 4 is a cross-sectional view taken along the line IV-IV of FIG. 3.

FIG. 5 is a cross-sectional view taken along the line V-V of FIG. 4.

FIG. 6 is a cross-sectional view taken along the line of VI-VI of FIG. 4.

FIG. 7 is a plan view of a closed end surface side of a ring case of an electromagnet assembly for use in an electromagnetic apparatus, according to a first embodiment of the present invention.

FIG. 8 is a cross-sectional view taken along the line of VIII-VIII of FIG. 7.

FIG. 9 is a cross-sectional view of a case and a cap of a connector of the electromagnet assembly before the cap is secured fixedly to the case, according to the first embodiment of the present invention.

FIG. 10 is a cross-sectional view of a case and a cap of a connector of an electromagnet assembly before the cap is secured fixedly to the case, according to a second embodiment of the present invention.

FIG. 11 is a cross-sectional view of a case and a cap of a connector of an electromagnet assembly before the cap is secured fixedly to the case, according to a third embodiment of the present invention.

FIG. 12 is a cross-sectional view of a case and a cap of a connector of an electromagnet assembly before the cap is secured fixedly to the case, according to a fourth embodiment of the present invention.

FIG. 13 is a cross-sectional view of a case and a cap of a connector of an electromagnet assembly before the cap is secured fixedly to the case, according to a fifth embodiment of the present invention.

FIG. 14 is a cross-sectional view of a case and a cap of a connector of an electromagnet assembly before the cap is secured fixedly to the case, according to a sixth embodiment of the present invention.

FIG. 15 is a cross-sectional view of a case and a cap of a connector of an electromagnet assembly before the cap is secured fixedly to the case, according to a seventh embodiment of the present invention.

FIG. 16 is a cross-sectional view of a case and a cap of a connector of an electromagnet assembly before the cap is secured fixedly to the case, according to a eighth embodiment of the present invention.

FIGS. 17a and 17b are cross-sectional views of a case and a cap of a connector of an electromagnet assembly before the cap is secured fixedly to the case, according to a ninth embodiment of the present invention.

### DETAILED DESCRIPTION OF PREFERRED EMBODIMENTS

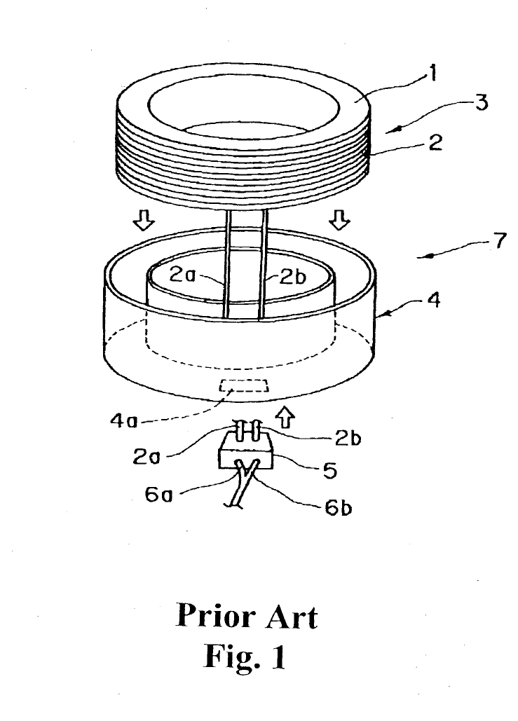

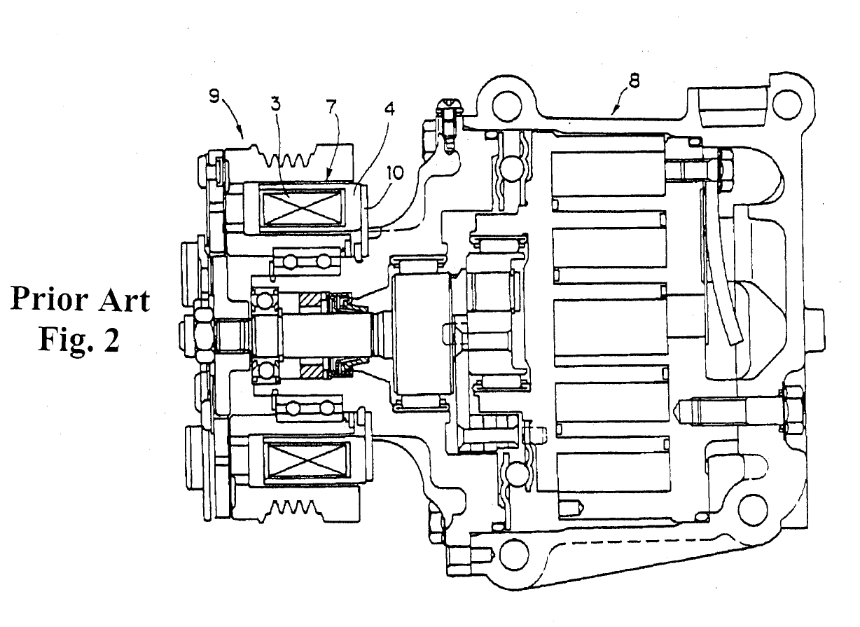

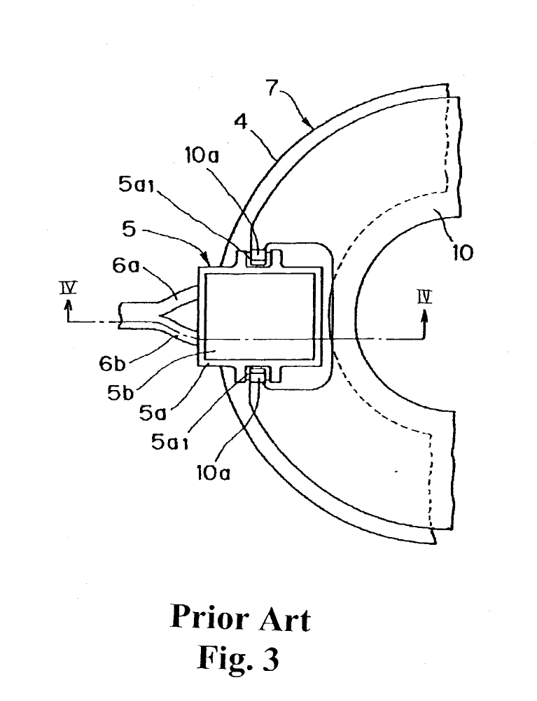

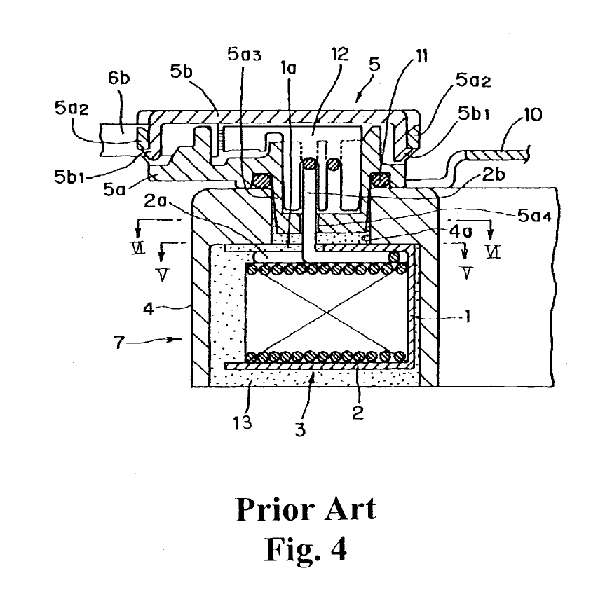

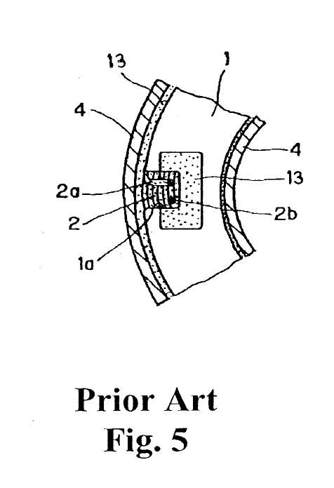

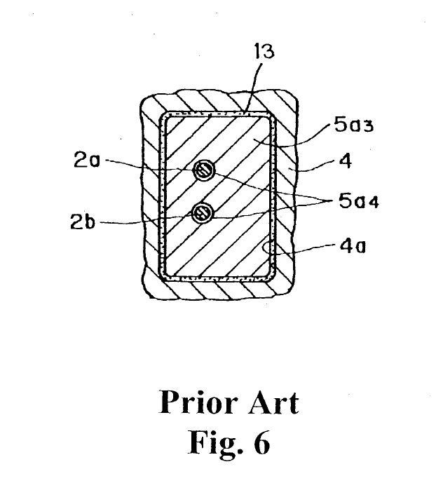

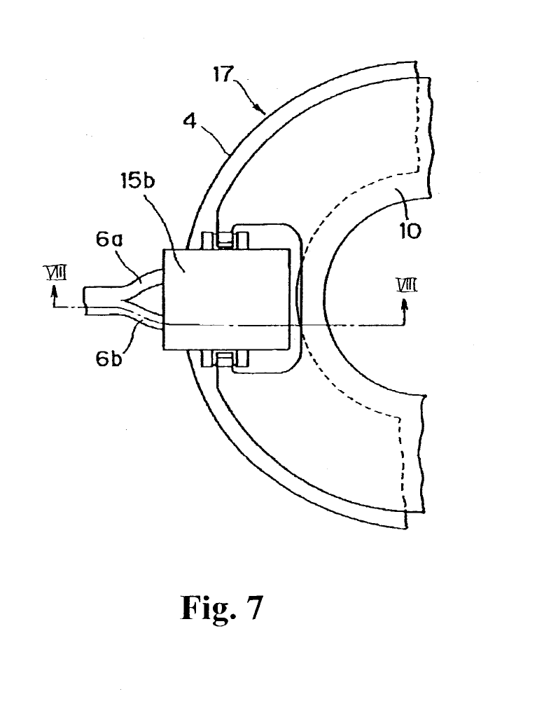

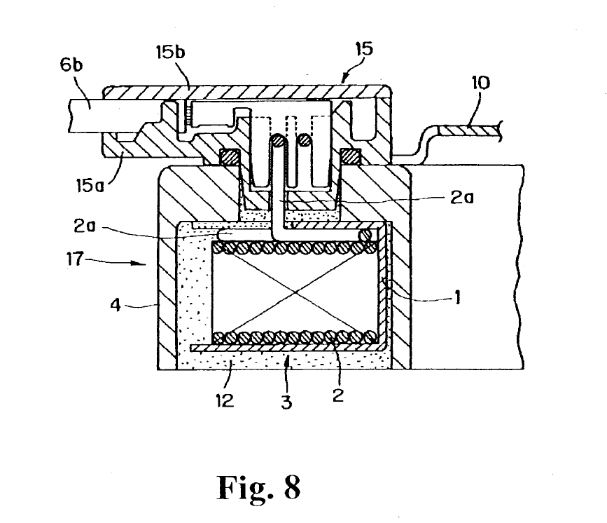

Referring to FIGS. 7-9, a first embodiment of the present invention of an electromagnet assembly for use in an electromagnetic apparatus, e.g., an electromagnetic clutch, is shown. In the following explanation and FIGS. 7-9, the same reference numbers are used to represent the same parts of an electromagnet assembly 17 for use in an electromagnetic apparatus as shown FIGS. 1-6. Therefore, further explanation of similar parts is here omitted.

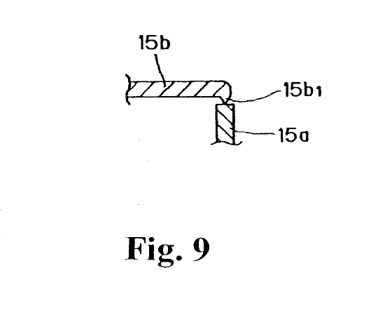

In electromagnet assembly 17 according to this embodiment, a cap 15b of a connector 15 is secured fixedly to an open end surface of a case 15a of connector 15 by a high frequency adhesion or an ultrasonic adhesion, or the like. As shown in FIG. 9, a projection portion 15bₗ is formed around a fringe portion of a first end surface of cap 15b and abuts the open end surface of case 15a. In FIG. 9, cap 15b is not secured fixedly on an open end surface of case 15a. A resin, e.g., an epoxy resin, is not poured into an interior of case 15. The structure of electromagnet assembly 17 of this embodiment is substantially the same as the known electromagnet assembly 7, except as described above.

In electromagnet assembly 17, cap 15b covers the open end surface of case 15a. Cap 15b is secured fixedly to the open end surface of case 15a, and the abutting portions of cap 15b and case 15a are melted and fixed together. A process for fixing cap 15b to case 15a may be easily automated. Consequently, the manufacturing efficiency of fixing cap 15b to case 15a may be increased. No gap is present between cap 15b and case 15a after cap 15b has been securedly fixedly to the open end surface of case 15a. Therefore, the entry of water into the interior of case 15a may be prevented. As a result, filling the interior of case 15a with the resin is no longer necessary. A projection portion 15b₁ , which is formed around a fringe portion of a first end surface of cap 15b and covers the open end surface of case 15a, has a smaller cross-sectional area and a smaller cubic volume compared to cap 15b. Therefore, projection portion 15b₁ is readily and completely melted, and may adhere strongly to the open end surface of case 15a. As a result, cap 15b may be fixed securely to case 15a.

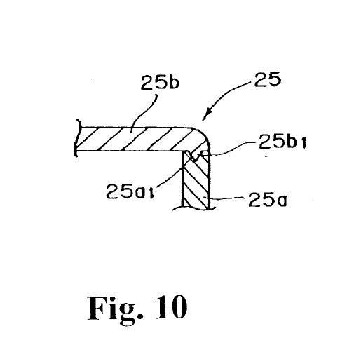

Referring to FIG. 10, a second embodiment of the present invention of an electromagnet assembly for use in an electromagnetic apparatus is shown. In this embodiment of an electromagnet assembly, a projection portion 25b₁ is formed around a fringe portion of a first end surface of a cap 25b of a connector 25 and abuts the open end surface of a case 25a of connector 25, and a concave portion 25a₁, which engages with projection portion 25b₁, is formed on the open end surface of a case 25a. In FIG. 10, cap 25b is not secured fixedly on an open end surface of case 25a. The structure of this embodiment of the electromagnet assembly is the same as the first embodiment of electromagnet assembly 17, except as described above. An area of the abutting portions between cap 25b and case 25a is increased because projection portion 25b₁ of cap 25b engages concave portion 25a₁ of case 25a. As a result, a fixing area of cap 25b and case 25a is increased, and, consequently, cap 25b may be more strongly fixed to case 25a.

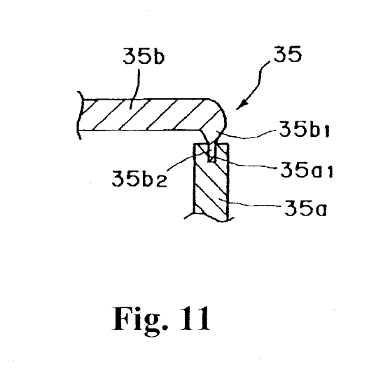

Referring to FIG. 11, a third embodiment of the present invention of an electromagnet assembly for use in an electromagnetic apparatus is shown. In this embodiment of an electromagnet assembly, a first projection portion 35b₁ is formed around a fringe portion of a first end surface of a cap 35b of a connector 35 and covers the open end surface of a case 35a of connector 35, and a plurality of second projection portions 35b₂, which determine a position for engaging cap 35b with case 35a, project from a tip of first projection portion 35b₁ at proper positions. A concave portion 35a₁, which faces the plurality of second projection portions 35b₂ and engages with the plurality of second projection portions 35b₂, is formed on the open end surface of a case 35a. In FIG. 11, cap 35b is not secured fixedly on an open end surface of case 35a. The structure of this embodiment of the electromagnet assembly is substantially the same as the first embodiment of electromagnet assembly 17, except as described above. Consequently, when preparations for fixing are completed, cap 35b may be readily positioned against case 35a because the plurality of second projection portions 35b₂ of cap 35b engage concave portion 35aₗ of case 35a. As a result, the process for fixing cap 35b to case 35a may achieve increased productivity.

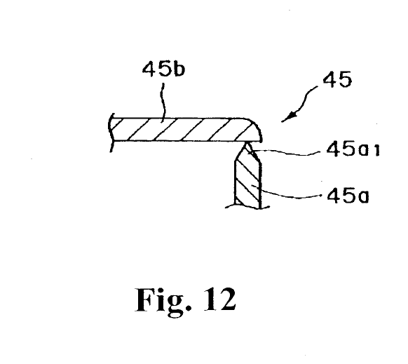

Referring to FIG. 12, a fourth embodiment of the present invention of an electromagnet assembly for use in an electromagnetic apparatus is shown. In this embodiment of an electromagnet assembly, a projection portion 45a₁ is formed on the open end surface of a case 45a along its open end surface of case 45a of a connector 45. In FIG. 12, a cap 45b is not secured fixedly on an open end surface of case 45a. The structure of this embodiment of the electromagnet assembly is the same as the first embodiment of electromagnet assembly 17, except that a projection portion is formed on an open end surface of a case instead of forming a projection portion on a cap. Projection portion 45a₁, which is formed on the open end surface of case 45a, has a smaller cross-sectional area and a smaller cubic volume, as compared to case 45a. Therefore, projection portion 45a₁ is readily and completely melted and may adhere strongly to cap 45b. As a result, cap 45b may be more strongly fixed to case 45a.

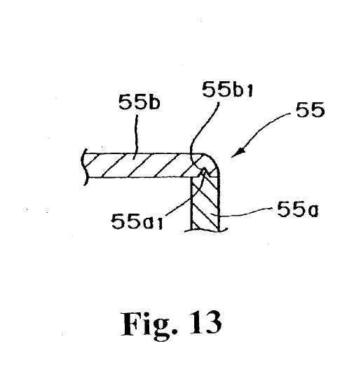

Referring to FIG. 13, a fifth embodiment of the present invention of an electromagnet assembly for use in an electromagnetic apparatus is shown. In this embodiment of an electromagnet assembly, a projection portion 55a₁ is formed on an open end surface of a case 55a along the open end surfac of a connector 55, and a concave portion 55b₁, which engages with projection portion 55a₁, is formed around a fringe portion of a first end surface of a cap 55b. In FIG. 13, cap 55b is not secured fixedly on the open end surface of case 55a. The structure of this embodiment of the electromagnet assembly is substantially the same as the first embodiment of electromagnet assembly 17, except as described above. An area of the abutting portions of cap 55b and of case 55a is increased because projection portion 55a₁ of case 55a engages concave portion 55b₁ of cap 55b. As a result, a fixing area of cap 55b and case 55a is increased, and cap 55b may be more strongly fixed to case 55a.

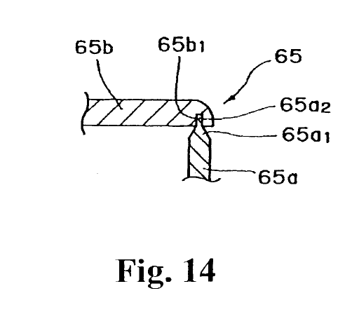

Referring to FIG. 14, a sixth embodiment of the present invention of an electromagnet assembly for use in an electromagnetic apparatus is shown. In this embodiment of an electromagnet assembly, a first projection portion 65a₁ is formed on an open end surface of a case 65a along the open end surface of a connector 65 and abuts a fringe portion of a first end surface of a cap 65b, and a plurality of second projection portions 65a₂, which determine a position for engaging cap 65b with case 65a, project from a tip of first projection portion 65a₁ at appropriate positions. A concave portion 65b₁, which faces the plurality of second projection portions 65a₂ and engages with the plurality of second projection portions 65a₂, is formed around the fringe portion of cap 65b. In FIG. 14, cap 65b is not secured fixedly on the open end surface of case 65a. The structure of this embodiment of the electromagnet assembly is substantially the same as electromagnet assembly 17, except as described above. Consequently, when preparations for fixing are completed, cap 65b may be readily positioned against case 65a because the plurality of second projection portions 65a₂ of case 65a engage concave portion 65b₁ of cap 65b. As a result, the process for fixing cap 65b to case 65a may achieve increased productivity.

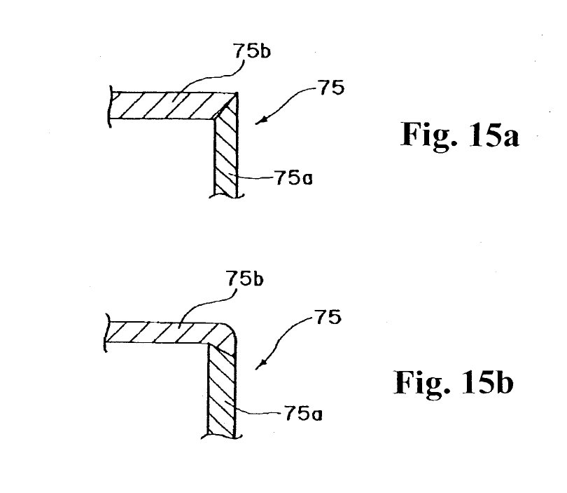

Referring to FIGS. 15a and 15b, a seventh embodiment of the present invention of an electromagnet assembly for use in an electromagnetic apparatus is shown. In this embodiment of an electromagnet assembly, an open end surface of a case 75a of a connector 75 is angled, and a fringe portion of a first end surface of a cap 75b, which faces the open end surface of case 75a, is angled to correspond to the angled open end surface of case 75a. For example, in FIG. 15a, the angle portion of case 75a and cap 75b bisect the corner formed by their abutment. Alternatively, in FIG. 15b, the corner formed by the abutment of case 75a and cap 75b is primarily comprised of cap 75b. In FIGS. 15a and 15b, cap 75b is not secured fixedly on the open end surface of case 75a. The structure of this embodiment of the electromagnet assembly is substantially the same as the first embodiment of electromagnet assembly 17, except that the open end surface of a case 75a and the fringe portion of a first end surface of a cap 75b are angled. An area of the abutting portion between cap 75b and case 75a is increased because the angled fringe portion of the first end surface of a cap 75b abuts the angled open end surface of case 75a. As a result, fixing area of cap 75b and case 75a is increased, and cap 75b may be more strongly fixed to case 75a.

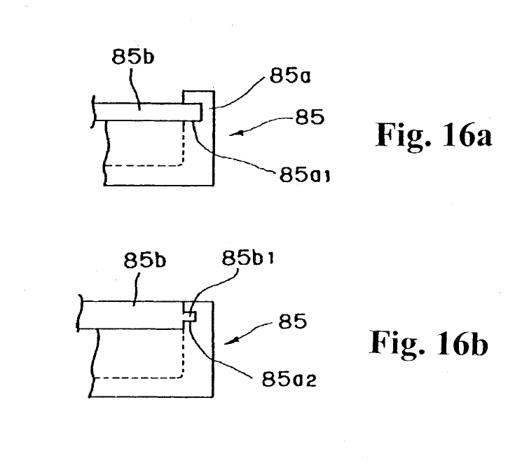

Referring to FIGS. 16a and 16b, an eighth embodiment of the present invention of an electromagnet assembly for use in an electromagnetic apparatus is shown. In this embodiment of an electromagnet assembly, as shown in FIG. 16a, a groove 85a₁ is formed on an interior side wall of a case 85a of a connector 85 and is adjacent to an open end surface of case 85a. A fringe portion of a cap 85b of connector 85 is inserted into groove 85a₁. As shown in FIG. 16b, a groove 85a₂ is formed on an interior side wall of case 85a of connector 85 and is adjacent to an open end surface of case 85a. A projection portion 85b₁, which is formed around a side wall of cap 85b, is inserted into groove 85a₂ of case 85a. In FIGS. 16a and 16b, cap 85b is not secured fixedly to the open end surface of case 85a. The structure of this embodiment of the electromagnet assembly is substantially the same as the first embodiment of electromagnet assembly 17, except that a groove is formed on a case or a projection portion is formed on a cap and a groove is formed on a case. In this embodiment, fringe portion of a cap 85b is inserted into groove 85a₁ formed on the interior side wall of case 85a and adjacent to the open end surface of case 85a. Alternatively, projection portion 85b₁ formed around the side wall of cap 85b is inserted into groove 85a₂ formed on the interior side wall of case 85a and is adjacent to the open end surface of case 85a. Therefore, an area of the abutting portion between cap 85b and case 85a is increased, and a fixing area between cap 85b and case 85a is increased. As a result, cap 85b may be more strongly fixed to case 85a.

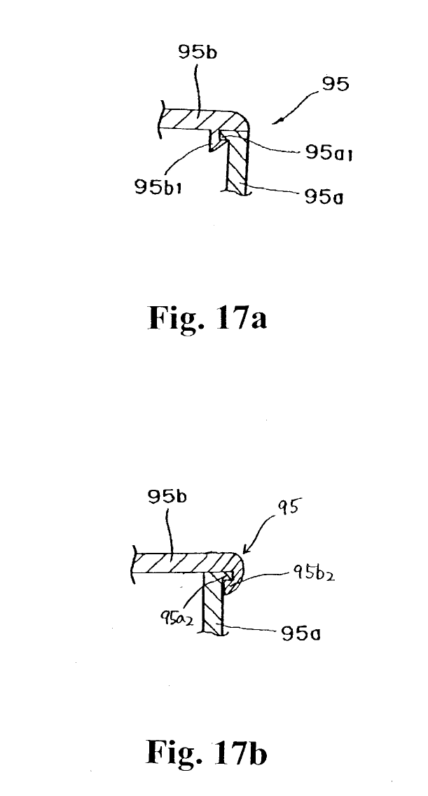

Referring to FIGS. 17a and 17b, a ninth embodiment of the present invention of an electromagnet assembly for use in an electromagnetic apparatus is shown. In this embodiment of an eleotromagnet assembly, as shown in FIG. 17a, a projection portion 95a₁ is formed around an interior wall at an open end surface of a case 95a of a connector 95. A hook portion 95b₁, which is formed on a first end surface of cap 95b, extends to engage projection portion 95a₁ of case 95a. As shown in FIG. 17b, a projection portion 95a₂ is formed around the exterior wall at the open end surface of a case 95a, and a hook portion 95b₂ is formed on the first end surface of cap 95b. Hook portion 95b₂ extends against projection portion 95a₂ of case 95a and engages projection portion 95a₂. In FIGS. 17a and 17b, cap 95b is not secured fixedly on the open end surface of case 95a. The structure of this embodiment of the electromagnet assembly is substantially the same as the first embodiment of electromagnet assembly 17, except that a projection portion is formed on a case and a hook portion is formed on a cap. In this embodiment, hook portion 95b₁ or hook portion 95b₂ of cap 95b engages with projection portion 95a₁ or projection portion 95a₂ of case 95a. Therefore, an area of the abutting portion between cap 95b and case 95a is increased, and a fixing area of cap 95b and case 95a is increased. As a result, cap 95b may be more strongly fixed to case 95a.

As described above, in the embodiments of the present invention of an electromagnet assembly for use in an electromagnetic apparatus, a cap is secured fixedly to an open end surface of a case by abutting the cap to the open end surface of the case of a connector. The process for fixing the cap to the case may be readily automated, and the manufacturing efficiency of fixing the cap to the case may be increased. The entry of water into an interior of the case may be prevented because the gap between the cap and the case is no longer formed after the cap is secured fixedly to the case. As a result, it is no longer necessary to fill the interior of the case with a resin, e.g., an epoxy resin. A projection portion, which is formed around a fringe portion of the first end surface of the cap and abuts the open end surface of the case, has a smaller cross-sectional area, and a smaller cubic volume, when compared to the cap. Therefore, the projection portion is readily and completely melted, and may adhere strongly to the open end surface of the case. As a result, the cap may be more strongly fixed to the case.

Although the present invention has been described in connection with preferred embodiments, the invention is not limited thereto. It will be understood by those skilled in the art that variations and modifications may be made within the scope and spirit of this invention, as defined by the following claims.

What is claimed is:

1. An electromagnet assembly for an electromagnetic apparatus comprising:
a ring member comprising a tubular spool with a pair of annular flanges projecting radially from said spool;
a coil bobbin comprising said ring member and an electrical wire, said electrical wire wound around said spool between said flanges;
a ring case comprising an annular groove, which has an open edge, said coil bobbin disposed in said annular groove;
an opening formed through said ring case adjacent to a closed end surface of said ring case;
a connector comprising a case and a cap, said case having a closed shape and a bottom, said cap closing an open end of said case, said connector disposed on said ring case adjacent to said closed end surface and covering said opening; and
a first end and a second end of said electrical wire, and a first lead wire and a second lead wire of an external electric circuit connected to said first and said second ends, respectively in said connector,
wherein a projection portion is formed around a fringe portion of a first end surface of said cap and abuts said open end surface of said case, wherein said cap is secured fixedly to said case after said projection portion is melted.

2. The electromagnet assembly of claim 1, wherein a concave portion is formed on said open end surface of said case and engages said projection portion of said cap.

3. The electromagnet assembly of claim 1, wherein a plurality of projection portions are formed on said first end surface of said cap for engaging with said case, and a plurality of concave portions are formed on said open end surface of said case for engaging said cap, wherein said projection portions engages said concave portions.

4. An electromagnet assembly for an electromagnetic apparatus comprising:
a ring member comprising a tubular spool with a pair of annular flanges projecting radially from said spool;
a coil bobbin comprising said ring member and an electrical wire, said electrical wire wound around said spool between said flanges;
a ring case comprising an annular groove, which has an open edge, said coil bobbin disposed in said annular groove;
an opening formed through said ring case adjacent to said closed end surface of said ring case;
a connector comprising a case and a cap, said case having a closed shape and a bottom, said cap closing an open end of said case, said connector disposed on said ring case adjacent to said closed end surface and covering said opening; and
a first end and a second end of said electrical wire, and a first lead wire and a second lead wire of an external electric circuit connected to said first and said second ends, respectively in said connector,
wherein a projection portion is formed along an open end surface of said case and abuts a first end surface of said cap, wherein said cap is secured fixedly to said case after said projection portion is melted.

5. The electromagnet assembly of claim 4, wherein a concave portion is formed on said first end surface of said cap and engages said projection portion of said case.

6. The electromagnet assembly of claim 4, wherein a plurality of projection portions are formed on said open end surface of said case for engaging said cap, and a plurality of concave portions are formed on said first end surface of said cap for engaging said case, wherein said projection portions engages said concave portions.

7. An electromagnet assembly for an electromagnetic apparatus comprising:
a ring member comprising a tubular spool with a pair of annular flanges projecting radially from said spool;
a coil bobbin comprising said ring member and an electrical wire, said electrical wire wound around said spool between said flanges;
a ring case comprising an annular groove, which has an open edge, said coil bobbin disposed in said annular groove;
an opening formed through said ring case adjacent to a closed end surface of said ring case;
a connector comprising a case and a cap, said case having a closed shape and a bottom, said cap closing an open end of said case, said connector disposed on said ring case adjacent to said closed end surface and covering said opening; and
a first end and a second end of said electrical wire, and a first lead wire and a second lead wire of an external electric circuit connected to said first and said second ends, respectively in said connector,
wherein an open end surface of said case is angled, and a fringe portion of a first end surface of said cap faces said open end surface of said case and is angled to conform to said open end surface of said case, wherein said cap is secured fixedly to said case after said open end surface of said case and said fringe portion of said first end surface of said cap are melted.

8. An electromagnet assembly for an electromagnetic apparatus comprising:
a ring member comprising a tubular spool with a pair of annular flanges projecting radially from said spool;
a coil bobbin comprising said ring member and an electrical wire, said electrical wire wound around said spool between said flanges;
a ring case comprising an annular groove, which has an open edge, said coil bobbin disposed in said annular groove;
an opening formed through said ring case adjacent to a closed end surface of said ring case;
a connector comprising a case and a cap, said case having a closed shape and a bottom, said cap closing an open end of said case, said connector disposed on said ring case adjacent to said closed end surface and covering said opening; and
a first end and a second end of said electrical wire, and a first lead wire and a second lead wire of an external electric circuit connected to said first and said second ends, respectively in said connector,
wherein a groove is formed on an interior side wall of said case and is adjacent to said open end surface of said case, and a fringe portion of said cap is inserted into said groove.

9. An electromagnet assembly for an electromagnetic apparatus comprising:
a ring member comprising a tubular spool with a pair of annular flanges projecting radially from said spool;
a coil bobbin comprising said ring member and an electrical wire, said electrical wire wound around said spool between said flanges;
a ring case comprising an annular groove, which has an open edge, said coil bobbin disposed in said annular groove;
an opening formed through said ring case adjacent to a closed end surface of said ring case;
a connector comprising a case and a cap, said case having a closed shape and a bottom, said cap closing an open end of said case, said connector disposed on said ring case adjacent to said closed end surface and covering said opening; and
a first end and a second end of said electrical wire, and a first lead wire and second lead wire of an external electric circuit connected to said first and said second ends, respectively in said connector,
wherein a projection portion is formed around an interior wall at said open end surface of said case, and a hook portion is formed on a first end surface of said cap and extends against and engages said projection portion.

10. An electromagnet assembly for an electromagnetic apparatus comprising:
a ring member comprising a tublar spool with a pair of annular flanges projecting radially from said spool;
a coil bobbin comprising said ring member and an electrical wire, said electrical wire wound around said spool between said flanges;
a ring case comprising an annular groove, which has an open edge, said coil bobbin disposed in said annular groove;
an opening formed through said ring case adjacent to a closed end surface of said ring case;
a connector comprising a case and a cap, said case having a closed shape and a bottom, said cap closing an open end of said case, said connector disposed on said ring case adjacent to said closed end surface and covering said opening; and
a first end and a second end of said electrical wire, and a first lead wire and a second lead wire of an external electric circuit connected to said first and said second ends, respectively in said connector,
wherein a projection portion is formed around an exterior wall at said open end surface of said case, and a hook portion is formed on a first end surface of said cap and extends against and engages said projection portion.
